(19) United States
(12) Patent Application Publication
(10) Pub. No.: US 2026/0326721 A1
(43) Pub. Date: Oct. 22, 2026

(54) MOTOR VEHICLE COMPRISING MULTIPLE SENSORS AND A CLEANING DEVICE, AND METHOD FOR OPERATING A CLEANING DEVICE

(71) Applicant: AUDI AG, Ingolstadt (DE)

(72) Inventors: Thomas HANISCH, Dollnsteib (DE); Mike HERBIG, Beilngries (DE); Martina BUSCH, Ingolstadt (DE)

(73) Assignee: AUDI AG, Ingolstadt (DE)

(21) Appl. No.: 19/100,991

(22) PCT Filed: Sep. 20, 2023
(86) PCT No.: PCT/EP2023/075866

§ 371 Date: Feb. 4, 2025

(30) Foreign Application Priority Data
Oct. 20, 2022 (DE) 10 2022 127 721.6

(51) Int. Cl. B60S 1/56; B60S 1/48; B60S 1/50; C25B 1/042; G01F 23/28

(52) U.S. Cl. CPC B60S 1/56; B60S 1/481; B60S 1/50; G01F 23/28; C25B 1/042

(57) ABSTRACT

A motor vehicle with multiple sensors and a cleaning device for applying a water-based cleaning fluid obtained from a fluid reservoir to the sensors. An electro-catalytic unit is provided for producing an end product in the form of an alcohol from water of the cleaning fluid and air as reactants, which end product can be added to the cleaning fluid as an additive.

### FIELD

The invention relates to a motor vehicle with multiple sensors and a cleaning device for applying a water-based cleaning fluid obtained from a fluid reservoir to the sensors.

### BACKGROUND

As the automation and autonomization of motor vehicles increases, the number of sensors required for the associated technologies also increases. In particular, sensors located on the outside of the vehicle must be cleaned cyclically and depending on the degree of contamination. This of course also increases the consumption of required cleaning water, also referred to in the following as cleaning fluid. This consumption was predicted to be approximately 10 liters per 450 km for Level 4 motor vehicles. The user of the motor vehicle must not only remember to regularly refill the water in the cleaning fluid, but also, at least in the colder seasons, to procure a suitable antifreeze and add it to the cleaning fluid. The procurement is com-plex, as it usually requires a trip to a gas station, so this is sometimes omitted and no antifreeze is added, which can lead to the cleaning fluid freezing up and cleaning the sensors no longer being possible.

### SUMMARY

The object of the invention is to specify an improved motor vehicle.

To solve the problem, a motor vehicle of the type mentioned above has an electro-catalytic unit for producing an end product in the form of an alcohol from water in the cleaning fluid and air as reactants, which end product can be added to the cleaning fluid as an additive.

The invention provides an electro-catalytic unit integrated in the motor vehicle, which allows the on-board production of an antifreeze in the form of an alcohol that can be added to the cleaning fluid. This supports the user and avoids the user having to purchase and store antifreeze separately. In particular, if the alcohol is automatically added to the cleaning fluid, as is preferred, manual addition is no longer necessary, thus ensuring that the cleaning fluid cannot freeze. The alcohol is produced from the water in the cleaning fluid, thus a medium that is already present in the vehicle.

In the electro-catalytic unit, both electrolytic and catalytic reactions take place. The unit has the appropriate components for these reactions. Electrolysis requires at least two electrodes, an anode and a cathode, connected to a direct current source. Catalysis requires at least one catalyst designed for the desired reaction. The electro-catalytic unit receives reactants from outside the unit. These reactants are water from the cleaning fluid and air. The water is electrolyzed in the electro-catalytic unit, producing hydrogen and oxygen as products of electrolysis. In at least one catalytic process, hydrogen from electrolysis, oxygen from electrolysis or air, and carbon dioxide from air are converted into an alcohol, for example by catalysis or synthesis. This alcohol is discharged from the electro-catalytic unit and added as an additive to the cleaning fluid in the fluid reservoir, which can be done manually or automatically. As an additive, alcohol serves as an antifreeze. The addition of alcohol to the cleaning fluid causes a lowering of the freezing point of the cleaning fluid. Since the invention provides a water-based cleaning fluid, it is advantageous if the alcohol has unlimited miscibility with water. Suitable alcohols would be methanol, ethanol and propan-1-ol. A particularly advantageous feature of alcohol as an additive is its ability to dissolve fat, which provides the cleaning fluid with an additional positive cleaning effect.

The electro-catalytic unit is preferably divided into three reaction chambers, wherein the reaction chambers are divided into an electrolysis chamber and a first catalysis chamber and a second catalysis chamber or synthesis chamber. This has the advantage that mixing of the reactants and products in the individual reaction steps is prevented. In addition, individual reaction chambers can be optimally designed for the specified reaction. For example, appropriate reaction temperatures and optimal pressures for gas reactions can be set in one of the catalysis chambers or synthesis chambers.

As a further option, the reaction chambers can preferably be designed modularly, so that in the event of a defective chamber, the entire electro-catalytic unit does not have to be removed, but only one chamber is replaced, which would make maintenance of the electro-catalytic unit more convenient.

In the electrolysis chamber, hydrogen (H₂) and oxygen (O₂) are preferentially produced as products from the water (H₂O) of the cleaning fluid. The reaction chamber contains two electrodes, a cathode and an anode, which are connected to a direct current source. Both electrodes are immersed in the cleaning fluid pumped into the chamber. The cleaning fluid, which consists entirely or at least mostly of water, is broken down into gases during electrolysis. The following overall reaction takes place:

2H₂O (f)→2H₂ (g)+O₂ (g),

where (f) indicates the liquid and (g) the gaseous state of the substances. This produces hydrogen (H₂) at the cathode and oxygen (O₂) at the anode. Optionally, the electrolysis chamber can be constructed similarly to a Hoffmann water decomposition apparatus. The two electrodes are located in different sub-chambers and the gaseous products then rise in these different sub-chambers and can be collected separately. The electrolysis chamber also has a corresponding line for the cleaning fluid to be supplied, which line leads from the fluid reservoir into the electrolysis chamber, as well as a line for the hydrogen (H₂), which line leads from the electrolysis chamber into a downstream first catalysis chamber, and optionally a line for oxygen (O₂), which line leads from the electrolysis chamber into a downstream second catalysis chamber or synthesis chamber.

In the first catalysis chamber, in a further development of the invention, an alkane (CₙH₂ₙ₊₂) is produced as a product from carbon dioxide (CO₂) from the air and hydrogen (H₂) from the electrolysis chamber as reactants. The first catalysis chamber contains a catalyst which is suitable for the intended reaction. In this chamber, two gaseous reactants react to form two gaseous products, with oxygen (O₂) being a by-product which can optionally be used in the later process, which is why separation of the products is not absolutely necessary in this case. The reactants flow from one side into the catalysis chamber through the catalyst, while the products are drawn out of the chamber at the other end. The following overall reaction takes place in the first catalysis chamber:

nCO₂ (g)+n+1H₂ (g)→CₙH₂ₙ₊₂ (g)+nO₂ (g).

It is worth mentioning that methane (n=1) and ethane (n=2) are lighter than carbon dioxide and rise above the carbon dioxide in the absence of air turbulence. This would allow the gases mentioned to be collected at the upper end of the chamber. The first catalysis chamber is connected to the other reaction chambers via lines. These lines include a hydrogen line that comes from the electrolysis chamber and a line that leads from the first catalysis chamber for the alkane and oxygen into the second catalysis chamber or synthesis chamber. In addition, a line is provided on the first catalysis chamber, which leads out of the electro-catalysis chamber to transport carbon dioxide from the ambient air into the first catalysis chamber. In order to increase the yield of the catalytic reaction, i.e. to shift the reaction equilibrium towards the products, the catalysis chamber can be designed in such a way that the chamber itself or the catalyst can be heated. In addition, it can be advantageous for the reaction equilibrium that, in addition to higher temperatures, higher pressures can also be produced in the chamber.

In the second catalysis chamber or synthesis chamber, in a further development of the invention, an alcohol can be produced as a product (CₙH₂ₙ₊₂O) from an alkane (CₙH₂ₙ₊₂), produced in the first catalysis chamber, and from oxygen (O₂) from the air and/or electrolysis chamber and/or catalysis chamber as reactants. The second catalysis chamber or synthesis chamber contains a catalyst that is intended for the reaction taking place there. In this reaction chamber, two gaseous reactants react to form a liquid product, which also represents the end product of the electro-catalytic unit. Here, the reactants flow from one side into the catalysis chamber or synthesis chamber through a catalyst and react according to the following overall reaction equation:

2CₙH₂ₙ₊₂ (g)+O₂ (g)→2CₙH₂ₙ₊₂O (f).

The liquid end product, an alcohol, can accumulate at the bottom of the chamber. It is particularly advantageous if the chamber bottom is designed like a funnel bottom or if the chamber bottom has a slope that slopes down towards a corner. This simplifies the collection of the liquid and its transfer into the liquid line for supply to the fluid reservoir. In addition to the alkane and oxygen line from the first catalysis chamber, a line for supplying air is added, preferably one that leads from the electro-catalysis chamber. In order to increase the yield of the catalytic reaction or synthesis, i.e. to shift the reaction equilibrium towards the products, the catalysis chamber or synthesis chamber itself or the catalyst can be heated. The reaction chamber can also be designed so that higher pressures can be achieved.

In addition to the electro-catalytic unit, a storage chamber can be provided for storing the alcohol produced. This has the advantage that if the fluid reservoir level is so low that no more alcohol can be produced, stored alcohol can still be added to the fluid reservoir when needed. Also if the cleaning fluid already contains sufficient antifreeze, which can be detected by measurement, for example, as will be discussed below, supply can be omitted. If such a storage is provided, the user can initiate a reserve production of alcohol via a menu item in the on-board console or by pressing a button. Of course, the storage chamber is connected via lines to the second catalysis chamber or synthesis chamber and the fluid storage.

In a preferred embodiment, one or more pumps are provided for conveying the reactants, the products and the end product, wherein one pump or a part of the pumps serve as dosing pumps. Positive displacement pumps, especially diaphragm pumps, are particularly suitable for this type of conveying, although these are also suitable as dosing pumps. The lines between the fluid reservoir and the electro-catalytic unit and the electro-catalytic unit to the fluid reservoir and any other line where dosing of liquids or gases appears appropriate should be provided with dosing pumps.

The fluid reservoir may have a sensor that can detect the alcohol content in the cleaning fluid. Depending on the sensor's detection result, the alcohol production in the electro-catalytic unit is controlled. If the alcohol content in the cleaning fluid is below a certain threshold value, which is stored in a control device that controls the operation, the production of the required amount of alcohol is started. For this purpose, a suitable amount of cleaning fluid is taken from the fluid reservoir, which is then converted into alcohol. If the determined alcohol content in the cleaning fluid is above a certain threshold value, which is stored in the control device, there is no need to produce alcohol using the electro-catalytic unit. The alcohol production for im-mediate addition to the fluid storage is automated via a control device that controls the corresponding components. The control device can, for example, be connected to a communication interface. Using wireless transmission methods, the communication interface can access weather data and transmit it to the control device, thus adjusting the alcohol content of the cleaning fluid to the forecast weather. This allows unusual cold periods or extremely low temperatures to be taken into account. It is also conceivable that the user can pre-determine a planned trip using a control element of an infotainment system and that the alcohol content in the antifreeze can be adjusted based on the geographically active or expected weather events, for example on a holiday trip to the Alps.

The fluid reservoir may preferably have a fill level sensor via which the fill level of the fluid reservoir can be detected. Without sufficient cleaning fluid, the cleanliness of the sensors, especially the external ones, cannot be guaranteed. Since contaminated sensors are only partially functional, highly automated driving functions would then have to be switched off. To prevent this, an optical and/or acoustic signal is issued to the vehicle user depending on the sensor's detection result. For example, a fill level information can be displayed on a display as a relative fill level indicator, where 100% is a full fluid reservoir and 0% is an empty fluid reservoir. Furthermore, when a certain level is reached, for example 25%, the user can be reminded to refill the fluid reservoir with water. An advantageous development could be that the cleaning fluid consumption can be extrapolated and the user is shown how many kilometers the fill level will last until he has to refill the water. If the fill level is too low, the removal of cleaning fluid for the purpose of producing alcohol can also be omitted, i.e. the removal can ultimately also be controlled depending on the fill level.

In a further development of the invention, at least one collecting device can be provided for collecting washer water when cleaning the sensors and/or condensate water on the evaporator of the air conditioning system and/or rainwater, wherein this water can be fed to the fluid reservoir. This further development has the advantage that the user no longer has to refill water into the fluid reservoir as often. This could significantly reduce the number of stops to refill water. In the case of an external sensor, for example, a channel-like collecting device can be provided in the region of the external sensor, which collects the draining cleaning fluid and is connected to the fluid reservoir via a line. The condensate on the evaporator of an air conditioning system can be collected in a collecting basin below the evaporator and fed into the fluid reservoir. The rainwater can be collected in the form of a gutter, e.g. at the lower edge of a windshield, whereby initial impurities in the water can be filtered out using a filter, e.g. a zeolite layer.

The fluid reservoir may have one inlet or multiple inlets and one outlet or multiple outlets, wherein a liquid filter is associated with the inlet or at least some of the inlets and the outlet or at least some of the outlets. Contaminants can be captured, especially when water is collected and/or cleaning fluid is recycled. To prevent the accumulation of contaminants in the cleaning fluid and especially in the fluid reservoir, liquid filters can be installed at suitable locations. It is also advantageous if no contaminants enter the electro-catalytic unit. Contaminants in the electro-catalytic unit can cause, among other things, clogged lines, incorrect reactions and broken catalysts. In this respect, it can also be advantageous to filter not only the liquids, but also the outside air that is sucked in.

In addition to the motor vehicle according to the invention, the invention also relates to a method for operating a cleaning device for cleaning sensors of a motor vehicle, in which an end product in the form of an alcohol to be added to the cleaning fluid as an additive is produced from water of the cleaning fluid and air as reactants in an electro-catalytic unit.

Preferably, at least two processes take place in the electro-catalytic unit, wherein at least one electrolysis process and at least one catalysis process or synthesis process are carried out in the electro-catalytic unit.

In a development of the method, three processes take place in the electro-catalytic unit: an electrolysis process, a first catalysis process and a second catalysis process or synthesis process. The division into several process steps has the advantage that optimal reaction conditions can be created for each process step in order to achieve a high yield and/or high production speeds. In the electrolysis process, oxygen and hydrogen are produced from water, wherein the water required for this comes from the cleaning fluid. In the first catalysis process, carbon dioxide from the air and hydrogen from the electrolysis process react with each other to form an alkane. The alkane is converted to an alcohol in a second catalysis process or synthesis process using oxygen, which comes either from the electrolysis process or as a byproduct from alkane production or from the air. The alcohol produced is then added to the cleaning fluid in the fluid reservoir.

In addition, an alcohol content in the cleaning fluid can be determined, wherein the production of the alcohol in the electro-catalytic unit is controlled depending on the determination result. If the alcohol content in the cleaning fluid is below a threshold value stored in the control device, the production process for the required amount of alcohol is started. This happens automatically. In addition, the production of alcohol can be started by the user himself at the push of a button or by operating a menu item, provided there is a storage option for the alcohol, and the alcohol produced is kept in stock.

The fill level of the fluid reservoir can be determined by measurement, wherein an optical and/or acoustic signal is issued to the user depending on the result of the determination. In a further development of the method, the fill level can also be displayed to the user.

### BRIEF DESCRIPTION OF THE FIGURES

Further advantages and details of the invention follow from the following exemplary embodiments and from the corresponding drawings. In particular, schematically:

FIG. 1 shows a schematic diagram of an exemplary embodiment of a device according to the invention, and

FIG. 2 shows a schematic diagram of an exemplary embodiment of an electro-catalytic unit.

### DETAILED DESCRIPTION

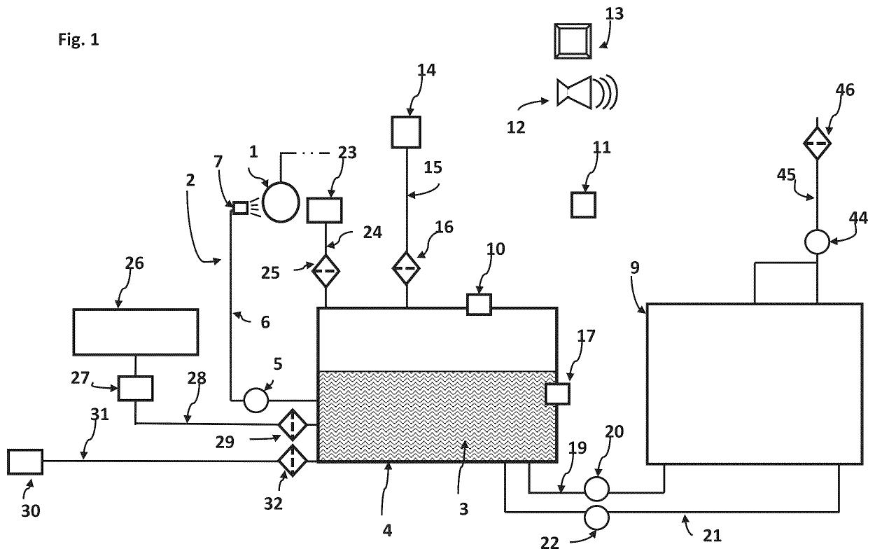

On a motor vehicle (not shown in detail) with a driver assistance system and/or highly automated driving functions, there are a plurality of sensors 1 which are arranged on the outside of the vehicle and serve, for example, to record information from the vehicle's surroundings. These sensors 1 are exposed to different weather conditions, dust, dirt and other contaminants, which can lead to the formation of a coating on the sensors and even to clogging. In order to ensure the continued functionality of these sensors 1, they must be cleaned regularly and depending on the degree of contamination. For this cleaning, a vehicle-side cleaning device 2 is provided, as shown in FIG. 1. For this purpose, a water-based cleaning fluid 3 is drawn from a fluid reservoir 4 and transported by a pump 5 via lines 6 into a spray nozzle 7. The spray nozzle 7 then cleans the external sensor 1 via a certain fluid pressure and also via the cleaning effect of the cleaning fluid 3.

Because the motor vehicle has multiple sensors 1, there is a high need for cleaning. This high cleaning requirement also results in a high consumption of cleaning fluid. Accordingly, the user of the motor vehicle must supply a larger quantity of cleaning fluid 3 to the fluid reservoir 4 at regular intervals. Not only water should be added to the fluid reservoir 4, but also, at least in the colder seasons, an appropriate amount of antifreeze. An alcohol 8 can be used as an antifreeze and is added to the cleaning fluid 3 as an additive. Alcohol 8 is produced on the vehicle side and as required. Production is made possible by an electro-catalytic unit 9 integrated into the vehicle. For the production of the alcohol 8 in the electro-catalytic unit 9, only the water in the cleaning fluid 3 and air are required, wherein ambient air is preferably used.

Furthermore, a control device 11 is provided which controls the operation of the electro-catalytic device and the other components integrated in the system and corresponds with the corresponding sensors, pumps, valves, etc. integrated in the system.

A fill level sensor 10 attached to the fluid reservoir 4 determines the level of the fluid reservoir 4. Depending on the result of the determination, an acoustic signal can be transmitted to the user via a suitable loudspeaker 12 or the like and/or an optical signal can be output to the user via a display device 13 such as a display or a light or the like. This signal can be a warning signal that indicates to the user that the fill level is below a certain threshold value, for example 25% fill level, and that timely refilling of the fluid reservoir 4 with water is necessary. It is also advantageous if the user of the motor vehicle is informed at all times about the current fill level of the fluid reservoir 4. This information can be displayed via a display on the dashboard or via a screen in the center console. Not only can the current fill level of the fluid reservoir 4 be displayed, but a predicted consumption can also be determined so that the user is shown how many kilometers the filling of the fluid reservoir 4 will last for.

If the driver needs to refill the fluid reservoir 4 with water, this is done via a tank opening 14. This tank opening 14 can, for example, be provided with a screw or plug connection in order to connect a water line to the motor vehicle. In the line 15, which connects the tank opening 14 with the fluid reservoir 4, there may be a liquid filter 16 to remove impurities from the water. If fresh water is supplied to the cleaning fluid 3 in the fluid reservoir 4, the concentration of the alcohol 8 that may already be present in the cleaning fluid 3 naturally also changes. In order to check whether the alcohol concentration in the cleaning fluid 3 is above a certain threshold value, an alcohol sensor 17 is provided on the fluid reservoir 4. The alcohol sensor 17 determines the alcohol concentration in the cleaning fluid 3. If the alcohol concentration is below a given limit, the control device 11 communicating with the alcohol sensor 17 starts the production process in the electro-catalytic unit 9. A certain amount of the cleaning fluid 3 is thus fed to the electro-catalytic unit 9 via a line 19 and a dosing pump 20. In the electro-catalytic unit 9, an alcohol 8 is then produced from the cleaning fluid 3 and air, as will be described below. This alcohol 8, which serves as antifreeze, is then fed back to the fluid reservoir 4 via a further line 21 and a dosing pump 22.

In this example, the water can not only be manually supplied by the user to the fluid reservoir 4 via the tank opening 14, but the motor vehicle itself can collect water via collecting devices in order to then supply it to the fluid reservoir 4. On the one hand, the cleaning fluid 3 that has already been used can be collected via a collecting device 23 on the external sensor 1. This can be done via small collecting channels around the external sensor 1. The collected water and/or cleaning fluid 3 is expediently passed through a liquid filter 25 before it reaches the fluid reservoir 4 via a line 24 so that no impurities can get into the fluid reservoir 4 and into the cleaning fluid 3. In the embodiment shown, the collection of condensate water is also provided at the evaporator 26, with a collecting basin 27 located below the evaporator 26 to collect condensate water. This water is also filtered through a liquid filter 29 before it reaches the fluid reservoir 4 via a line 28. Also provided is a collection of rainwater, preferably the rainwater from the windshield, wherein a collecting channel 30 is located at the lower end of the windshield so that the rainwater can be wiped into the collecting channel 30 by means of the windshield wipers. This collecting channel 30 can contain, for example, a zeolite filter so that the rainwater is pre-filtered to remove coarse dirt. Nevertheless, there is a liquid filter 32 in the line 31 of the rainwater collecting channel to the fluid reservoir 4 in order to separate even the last dirt from the water. These additional collecting devices mean that the vehicle user has to plan fewer stops to fill the fluid reservoir 4.

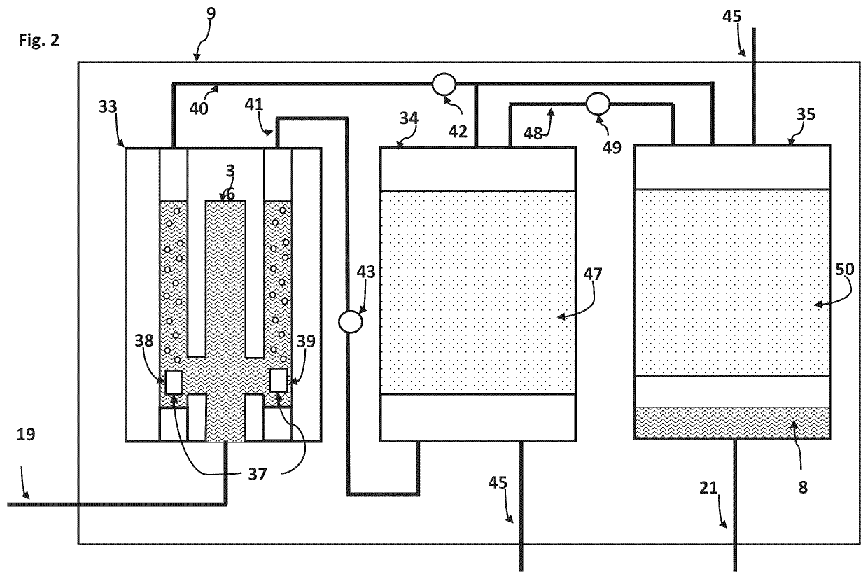

The electro-catalytic unit 9 is divided into three reaction chambers in FIG. 2, which are divided into an electrolysis chamber 33, a first catalysis chamber 34 and a second catalysis chamber or synthesis chamber 35. The cleaning fluid 3 is transported from the fluid reservoir 4 into the electro-catalytic unit 9 via a line 19 with the aid of a dosing pump 20, wherein the cleaning fluid 3 reaches the electrolysis chamber 33. The electrolysis chamber 33 can, for example, be constructed like a Hoffmann water decomposition apparatus, as is the case in this example. A reservoir 36 of the cleaning fluid 3 is divided into three interconnected sub-chambers. The two outer chambers on the left and right also form the sub-chambers that contain the electrodes 37. In the left sub-chamber there is an anode 38 and in the right sub-chamber there is a cathode 39. Both electrodes 37 are connected to each other via a direct current source. During electrolysis, the water in the cleaning fluid 3 is decomposed into oxygen and hydrogen. The respective gases rise in their sub-chambers, with oxygen rising and being collected at the anode 38 and hydrogen rising and being collected at the cathode 39.

Both gases are transported separately via lines 40, 41 and pumps 42, 43 into one of the next chambers, wherein the hydrogen is transported into the first catalysis chamber 34 and the oxygen into the second catalysis chamber or synthesis chamber 35. In addition to the hydrogen, carbon dioxide from the outside air is also fed into the first catalysis chamber 34 via a pump 44 or a blower via a line 45 provided for this purpose. It is advantageous if the air is cleaned via an air filter 46 before it enters the electro-catalytic unit. In the first catalysis chamber 34 there is a first catalyst 47, which is intended for the reaction taking place in the chamber. In the proposed reaction, hydrogen and carbon dioxide react to form an alkane and oxygen, with the alkane being the main product and oxygen being the byproduct. It is advantageous if oxygen and alkane are brought separately from the first catalysis chamber 34 via lines 40, 48 and with the aid of pumps 42, 49.

In this example, both the main product and the by-product of the first catalysis chamber 34 are transported to the second catalysis chamber or synthesis chamber 35. In the second catalysis chamber or synthesis chamber 35 there is a second catalyst 50 intended for the reaction in this chamber. In the second catalysis chamber or synthesis chamber 35, alkane and oxygen react catalytically to form an alcohol 8. Since the resulting alcohol 8 is liquid, it can simply drip onto the bottom of the second catalysis chamber or synthesis chamber 35. At the bottom of this reaction chamber, a line 21 with an associated dosing pump 22 opens, with which the alcohol 8 can then be dosed from the second catalysis chamber or synthesis chamber 35 into the fluid reservoir 4 and preferably guided depending on the alcohol content in the cleaning fluid measured with the alcohol sensor 17. Alcohol production or alcohol supply can continue until a certain alcohol content is measured again in the cleaning fluid.

1-16. (canceled)

17. A motor vehicle with multiple sensors and a cleaning device for applying a water-based cleaning fluid obtained from a fluid reservoir to the sensors; and
an electro-catalytic unit is provided for producing an end product in the form of an alcohol from water of the cleaning fluid and air as reactants, which end product can be added to the cleaning fluid as an additive.

18. The motor vehicle according to claim 17, wherein the electro-catalytic unit is divided into three reaction chambers, wherein the reaction chambers are divided into an electrolysis chamber and into a first catalysis chamber and a second catalysis chamber or synthesis chamber.

19. The motor vehicle according to claim 18, wherein in the electrolysis chamber hydrogen (H₂) and oxygen (O₂) can be produced as products from the water (H₂O) as a reactant, the water being a component of the cleaning fluid.

20. The motor vehicle according to claim 18, wherein in the first catalysis chamber an alkane (CₙH₂ₙ₊₂) can be produced as a product from carbon dioxide (CO₂) from the air and hydrogen (H₂) from the electrolysis chamber as reactants.

21. The motor vehicle according to claim 18, wherein in the second catalysis chamber or synthesis chamber an alcohol can be produced as end product (CₙH₂ₙ₊₂O) from an alkane (CₙH2n+2), produced in the first catalysis chamber, and from oxygen (O₂) from the air and/or electrolysis chamber as reactants.

22. The motor vehicle according to claim 18, wherein a storage chamber is provided for storing the alcohol produced.

23. The motor vehicle according to claim 18, wherein one or more pumps are provided for conveying the reactants, the products and the end product, wherein one pump or some of the pumps serve as dosing pumps.

24. The motor vehicle according to claim 17, wherein the fluid reservoir has a sensor via which the alcohol content in the cleaning fluid can be detected, wherein the alcohol production in the electro-catalytic unit can be controlled depending on a determination result.

25. The motor vehicle according to claim 17, wherein the fluid reservoir has a sensor via which the fill level of the fluid reservoir can be detected, wherein, depending on a determination result, an optical and/or acoustic signal can be output to the user of the motor vehicle.

26. The motor vehicle according to claim 17, wherein at least one collecting device is provided for collecting washer fluid when cleaning the sensors and/or condensate water on the evaporator of the air conditioning system and/or rainwater which can be fed to the fluid reservoir.

27. The motor vehicle according to claim 17, wherein the fluid reservoir has one inlet or multiple inlets and one outlet or multiple outlets, wherein a liquid filter is associated with the inlet or at least some of the inlets and with the outlet or at least some of the outlets.

28. A method for operating a cleaning device for cleaning sensors of a motor vehicle according to claim 17, wherein in an electro-catalytic unit an end product in the form of an alcohol to be supplied to the cleaning fluid as an additive is produced from water of the cleaning fluid and air as reactants.

29. The method according to claim 28, wherein at least one electrolysis process and at least one catalysis process or one synthesis process are carried out in the electro-catalytic unit.

30. The method according to claim 29, wherein in the electro-catalytic unit in an electrolysis process oxygen (O₂) and hydrogen (H₂) are produced from water (H₂O), and in a first catalysis process an alkane (CₙH₂ₙ₊₂) is produced from carbon dioxide (CO₂) from the air and hydrogen (H₂) from the electrolysis process, and in a second catalysis process or synthesis process an alcohol (CₙH₂ₙ₊₂O) (8) is produced from the alkane (CₙH₂ₙ₊₂) from the first catalysis process and oxygen (O₂) from the electrolysis process and/or air.

31. The method according to claim 28, wherein the alcohol content in the cleaning fluid is determined, wherein the production of the alcohol in the electro-catalytic unit is controlled depending on the result of the determination.

32. The method according to claim 29, wherein the fill level of the fluid reservoir is determined, wherein an optical and/or acoustic signal is output to the user depending on the determination result.

33. The motor vehicle according to claim 19, wherein in the first catalysis chamber an alkane (CₙH₂ₙ₊₂) can be produced as a product from carbon dioxide (CO₂) from the air and hydrogen (H₂) from the electrolysis chamber as reactants.

34. The motor vehicle according to claim 19, wherein in the second catalysis chamber or synthesis chamber an alcohol can be produced as end product (CₙH₂ₙ₊₂O) from an alkane (CₙH₂ₙ₊₂), produced in the first catalysis chamber, and from oxygen (O₂) from the air and/or electrolysis chamber as reactants.

35. The motor vehicle according to claim 20, wherein in the second catalysis chamber or synthesis chamber an alcohol can be produced as end product (CₙH₂ₙ₊₂O) from an alkane (CₙH₂ₙ₊₂), produced in the first catalysis chamber, and from oxygen (O₂) from the air and/or electrolysis chamber as reactants.

36. The motor vehicle according to claim 19, wherein a storage chamber is provided for storing the alcohol produced.
